(19) United States
(12) Patent Application Publication
(10) Pub. No.: US 2022/0050449 A1
(43) Pub. Date: Feb. 17, 2022

(54) TECHNOLOGY CONFIGURED TO FACILITATE MONITORING OF OPERATIONAL PARAMETERS AND MAINTENANCE CONDITIONS OF PHYSICAL INFRASTRUCTURE

(71) Applicant: Willow IP PTY LTD, Sydney, NSW (AU)

(72) Inventors: Dale Brett, Queenscliff, NSW (AU); Adam Geha, Queenscliff, NSW (AU); Michael Easson, Queenscliff, NSW (AU); Josh Ridley, Queenscliff, NSW (AU)

(21) Appl. No.: 17/279,248

(22) PCT Filed: Sep. 21, 2019
(86) PCT No.: PCT/AU2019/051015

§ 371 Date: Mar. 24, 2021

(30) Foreign Application Priority Data
Sep. 24, 2018 (AU) 2018903582

(51) Int. Cl. G05B 23/02; G06F 16/27; G05B 15/02; H04L 29/08

(52) U.S. Cl. CPC G05B 23/0283; G06F 16/27; H04L 9/3236; H04L 67/12; G05B 15/02

(57) ABSTRACT

Technology is configured to facilitate monitoring of operational parameters and maintenance conditions of physical infrastructure. Some embodiments relate to an arrangement of hardware and software that are configured to perform monitoring of physical infrastructure operational parameters via a first set of sensor devices, and periodically write data to a blockchain, in combination with a second set of sensor devices that are configured to monitor for defined maintenance conditions, which are also written to the blockchain. This is preferably used as a means to drive determination of a reliability/availability measure for the infrastructure, and/or automatedly perform payment transactions for maintenance operations.

### CROSS-REFERENCE TO RELATED APPLICATIONS

This application is a national phase entry under 35 U.S.C. § 371 of International Patent Application PCT/AU2019/051015, filed Sep. 21, 2019, designating the United States of America and published as International Patent Publication WO 2020/061621 A1 on Apr. 2, 2020, which claims the benefit under Article 8 of the Patent Cooperation Treaty to Australian Patent Application Serial No. 2018903582, filed Sep. 24, 2018.

### TECHNICAL FIELD

The present disclosure relates, in various embodiments, to technology configured to facilitate monitoring of operational parameters and maintenance conditions of physical infrastructure. Some embodiments relate to an arrangement of hardware and software that is configured to perform monitoring of physical infrastructure operational parameters via a first set of sensor devices, and periodically write data to a blockchain, in combination with a second set of sensor devices that are configured to monitor for defined maintenance conditions, which are also written to the blockchain. This is in some embodiments used to drive determination of a reliability/availability measure for the infrastructure, and/or automatedly perform payment transactions for maintenance operations. While some embodiments will be described herein with particular reference to those applications, it will be appreciated that the present disclosure is not limited to such a field of use, and is applicable in broader contexts.

### BACKGROUND

Any discussion of the background art throughout the specification should in no way be considered as an admission that such art is widely known or forms part of common general knowledge in the field.

In a building environment, there are many instances of physical infrastructure that require maintenance. Examples include elevators, access control systems, HVAC systems, media presentation, and the like. Often, infrastructure is critical to operations in a building environment, for example, in the context of tenant businesses, access, safety, and so on. However, with the complexity of modern buildings, maintenance operations often tend to be reactive as a matter of practicality. This may be due to unforeseen technical issues; however often it is due to failures in the context of routine maintenance operations.

### BRIEF SUMMARY

It is an object of the present disclosure to overcome or ameliorate at least one of the disadvantages of the prior art, or to provide a useful alternative.

One embodiment provides a computer system configured to monitor maintenance conditions for a physical infrastructure system, the system including:
a set of infrastructure monitoring modules that are each configured to monitor a respective one or more physical devices associated with the physical infrastructure system, and, for each of the physical devices associated with the physical infrastructure system, determine a current operational parameter;
an infrastructure operational state block generation module that is configured to, on a defined schedule, execute a process that: (i) analyzes current data from the first set of monitoring modules; (ii) based on the analysis determines a system operational parameter, (iii) writes to a blockchain a block entry that includes an identifier that corresponds to the determined system operational parameter and associated timing information; and
a smart contract management module that operates in combination with one or more listener modules, wherein: (i) the smart contract management module is configured to execute code embodying a smart contract that accepts as input a plurality of variable values having defined attributes; and (ii) the listener modules are configured to monitor the blockchain thereby to identify each block entry that provides one of the plurality of variable values having the defined attributes, and for each identified block entry that provides one of the plurality of variable values, extract the value and deliver that value to the smart contract management module.

One embodiment provides a computer system wherein the plurality of variable values having defined attributes include variable values provided by block entries written to the blockchain by the infrastructure operational state block generation module, wherein the smart contract management module is configured to process the variable values provided by block entries written to the blockchain by the infrastructure operational state block generation module thereby to determine an infrastructure state result value for a defined period.

One embodiment provides a computer wherein the smart contract management module is configured to determine a contract outcome process in response to the determined infrastructure state result value.

One embodiment provides a computer system wherein the contract outcome process includes making of an automated electronic payment, wherein a payment amount for the payment is determined based on the determined infrastructure state result value.

One embodiment provides a computer system wherein the determined infrastructure state result value provides a scaling factor that is applied to a baseline payment value thereby to, at least in part, enable calculation of the payment amount.

One embodiment provides a computer system wherein the set of infrastructure monitoring modules that are each configured to monitor a respective one or more physical devices associated with the physical infrastructure system include software modules configured to obtain a defined value from a defined sensor on a defined schedule.

One embodiment provides a computer system wherein the defined sensor is a sensor configured for operation in a Building Management System.

One embodiment provides a computer system including:
a set of maintenance condition monitoring modules that are each configured to monitor a respective one or more physical devices, and, based on that monitoring identify events having defined characteristics;
a maintenance condition block generation module that is configured to, on a defined schedule, execute a process that: (i) accesses data for a given one of the identified events having defined characteristics; and (ii) writes to a blockchain a block entry that includes an identifier that corresponds to the identified event and associated timing information.

One embodiment provides a computer system wherein the one or more physical devices include a device configured to report on presence of a proximity relationship between a first electronic device and a target location.

One embodiment provides a computer system wherein the plurality of variable values having defined attributes include:
variable values provided by block entries written to the blockchain by the infrastructure operational state block generation module; and
variable values provided by block entries written to the blockchain by the maintenance condition block generation module;
wherein the smart contract management module is configured to process the variable values provided by block entries written to the blockchain by the infrastructure operational state block generation module thereby to determine:
an infrastructure state result value for a defined period; and
a maintenance condition result value for the defined period.

One embodiment provides a computer system wherein the smart contract management module is configured to determine a contract outcome process in response to a combination of: the determined infrastructure state result value; and the maintenance condition result value.

One embodiment provides a computer system wherein the contract outcome process includes making of an automated electronic payment, wherein a payment amount for the payment is determined based on a combination of: the determined infrastructure state result value; and the determined maintenance condition result value.

One embodiment provides a computer system wherein the determined infrastructure state result value and the determined maintenance condition result value combine to provide a scaling factor that is applied to a baseline payment value thereby to, at least in part, enable calculation of the payment amount.

One embodiment provides a computer system wherein the infrastructure operational state block generation module is configured to: write to a private ledger value data for each of a plurality of periodic readings of a given system operational parameter made over a predefined period; at the end of the predefined period, compile the data values for each of the plurality of periodic readings of the given system operational parameter made over the predefined period; and based on the compiling, define the blockchain entry such that the blockchain entry includes an identifier that corresponds to a compiling of the plurality of periodic readings of the given system operational parameter made over the predefined period, and associated timing information.

One embodiment provides a method for executing a smart contract based on monitoring of one or more sensors that are configured to monitor respective pieces of physical infrastructure, the method including:
configuring an infrastructure operational state block generation to process data derived from a given one of the sensors for a predefined period, thereby to:
   on a repeated basis, define an objective measure of infrastructure operational state for the predefined period; and
   write to a blockchain a series of block entries that includes an identifier that, respectively, convey each of the measures of infrastructure operational state for the predefined periods;
configuring one or more listener modules to monitor the blockchain, thereby to identify blockchain entries belonging to the series of blockchain entries, wherein the listener modules are additionally configured to extract from the identified blockchain entries the objective measures of operational state for the predefined periods, and pass those extracted objective measures of operational state to a smart contract management module; and
configuring the smart contract management module to execute computer code embodying a smart contract, wherein the smart contract accepts as input variable values the objective measures of operational state for the predefined periods.

One embodiment provides a method wherein executing the computer code embodying the smart contract includes determining an outcome process based on analysis of the objective measures of operational state for the predefined periods.

One embodiment provides a method wherein the outcome process is an automated payment process, and a payment amount for the automated payment process is calculated using a scaling factor derived based on the objective measures of operational state for the predefined periods.

One embodiment provides a system for enabling smart contract execution based on events defined by a set of sensors that monitor infrastructure in a building environment, the system including:
a smart contract management module configured to execute computer code embodying a smart contract, the smart contract having a plurality of defined data inputs;
a set of block generation modules that are configured to, based on defined rules, write to a blockchain block data defined based on monitoring of data output by one of more of the sensors that monitor infrastructure in a building environment; and
a set of listener modules, wherein the listener modules are configured to monitor the blockchain thereby to extract from the blockchain values corresponding to the defined data inputs of the smart contract;
wherein execution of the smart contract is variable in response to the extracted values corresponding to the defined data inputs.

One embodiment provides a system wherein at least a subset of the set of sensors that monitor infrastructure in a building environment is configured to deliver data to a Building Management System (BMS).

One embodiment provides a system wherein the set of block generation modules is initialized in response to execution of a portion of the code embodying the smart contract.

Reference throughout this specification to “one embodiment,” “some embodiments” or “an embodiment” means that a particular feature, structure or characteristic described in connection with the embodiment is included in at least one embodiment of the present disclosure. Thus, appearances of the phrases “in one embodiment,” “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising,” “comprised of,” or “which comprises” is an open term that means including at least the elements/features that follow, but not excluding others. Thus, the term “comprising,” when used in the claims, should not be interpreted as being limitative to the means or elements or steps listed thereafter. For example, the scope of the expression “a device comprising A and B” should not be limited to devices consisting only of elements A and B. Any one of the terms “including” or “which includes” or “that includes,” as used herein, is also an open term that also means including at least the elements/features that follow the term, but not excluding others. Thus, “including” is synonymous with, and means, “comprising.”

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the present disclosure will now be described, by way of example only, with reference to the accompanying drawings in which:

FIG. 1 illustrates a system diagram illustrating a blockchain in accordance with an aspect of the present disclosure.

FIG. 2 provides a system diagram illustrating validator nodes of the blockchain of FIG. 1 in accordance with an aspect of the present disclosure.

FIG. 3 provides a system diagram illustrating nodes storing the ledger of the blockchain of FIG. 1 in accordance with an aspect of the present disclosure;

FIG. 4 is a diagram illustrating a technological framework according to one embodiment.

FIG. 5 illustrates a flow chart of a method according to an embodiment of the present disclosure.

FIG. 6 illustrates a flow chart of a method according to an embodiment of the present disclosure.

FIG. 7 is an exemplary block diagram of a computer system in which processes involved in the system, method, and computer program product described herein may be implemented.

### DETAILED DESCRIPTION

Described herein is technology configured to facilitate monitoring of operational parameters and maintenance conditions of physical infrastructure. Some embodiments relate to an arrangement of hardware and software that is configured to perform monitoring of physical infrastructure operational parameters via a first set of sensor devices, and periodically write data to a blockchain, in combination with a second set of sensor devices that are configured to monitor for defined maintenance conditions, which are also written to the blockchain. This is preferably used as a means to drive implementation of a predefined smart contract, for example, to determine a reliability/availability measure for the infrastructure, and/or automatedly perform payment transactions for maintenance operations. While some embodiments will be described herein with particular reference to those applications, it will be appreciated that the present disclosure is not limited to such a field of use, and is applicable in broader contexts.

One embodiment provides a system for enabling smart contract execution based on events defined by a set of sensors that monitor infrastructure in a building environment. For example, the sensors optionally include sensors that are configured to deliver data to a Building Management System (BMS), including sensors that operate based on a BACNET® protocol. It will be appreciated that such sensors make available on a computer network (for example, via ETHERNET®) data that defines operational parameters of monitored physical infrastructure. The nature of monitored data varies between infrastructure types, for example, including operational status (which may be indicated by a lack of data, in the case of non-operation), temperatures, humidity, access control events, and so on.

A smart contract management module is configured to execute computer code embodying a smart contract. In this regard, a smart concept is an executable computer program that includes a plurality of defined data inputs and, during execution, operates in a variable manner based on predefined logic, in response to values those data inputs. In accordance with the present disclosure, the data inputs include data inputs extracted from block entries in a blockchain, wherein those block entries are defined in response to senor data.

In that regard, a set of block generation modules is configured to, based on defined rules, write to a blockchain block data defined based on monitoring of data output by one of more of the sensors that monitor infrastructure in a building environment. In one embodiment, those block generation modules are initialized in response to execution of a portion of the code embodying the smart contract. For example, the smart contact includes code that defines:
A specific sensor from which data is to be obtained (or set of specific sensors from which data is to be obtained);
A protocol by which that data is to be obtained (for example, a query that is to be executed requesting a particular operational parameter on a defined schedule, or monitoring for events having defined characteristics).
Rules for defining block entry data (which may include initial recording of a plurality of data values in a private ledger prior to aggregation of those data values into a periodic value that is used for the purpose of defining the block entry to be written to the blockchain).

A set of listener modules are executed, these being configured to monitor the blockchain thereby to extract from the blockchain values corresponding to the defined data inputs of the smart contract. Again, these are in one embodiment initialized based on the smart contract code (for example, the smart contract code causes configuration and execution of listener modules that monitor the blockchain for blocks having defined attributes, these defined attributes indicating that a contract-required data input is extractable from the block). The listener modules identify the relevant blocks in the blockchain, and allow extraction of values for the defined data inputs, which are passed to the smart contract. The smart contract, based on the logic defined by its executing computer code, then continues its operation in response to those values. For example, in some cases the operation of the smart contract includes executing a process that causes an electronic payment transaction to occur, and a transaction amount for that transaction is determined based on processing of one or more of the data input values.

As context, blockchain technology was developed as a way of providing a publicly transparent and decentralized ledger that is configured to track and store digital transactions in a publicly verifiable, secure, and hardened manner to prevent tampering or revision.

A typical blockchain includes three primary functions: read, write, and validate. For example, a user of the blockchain (for example, a user in the form of an executing software application) must have the ability to read the data that resides on the blockchain. A user of the blockchain must also have the ability to write, e.g., append, data to the blockchain. Every write operation starts out as a proposed transaction that is posted on the network. The proposed transaction may not always be valid, for example, it may be malformed (syntax errors), or it may constitute an attempt to perform a task for which the submitter is not authorized. Validation refers to filtering out invalid transactions and then deciding on the exact order for the remaining, valid, transactions to be appended to the blockchain. This process is often called consensus.

Once ordered, the transactions are packaged into blocks that are in turn appended to the blockchain. Each new block that is appended to the blockchain also includes a hash of the previous block. Accordingly, as each new block is added, the security and integrity of the entire blockchain is further enhanced. It is important to note that once data is written to the blockchain, for example, once a block including transactions has been appended to the blockchain, that data can no longer be altered or modified. In a typical blockchain, the anonymity of the users is protected through the use of pseudonyms and the transaction data itself is protected through the use of cryptography, e.g., via the use of hash codes.

Recently, the use of blockchain technology has expanded beyond crypto currency, to provide a framework for the execution of smart contracts. Smart contracts are self-executing agreements between parties that have all of the relevant covenants spelled out in code, and settle automatically, depending on future signatures or trigger events. By leveraging blockchain technologies, smart contracts, once appended to the blockchain, cannot be revoked, denied, or reversed, since decentralized execution removes them from the control of any one party.

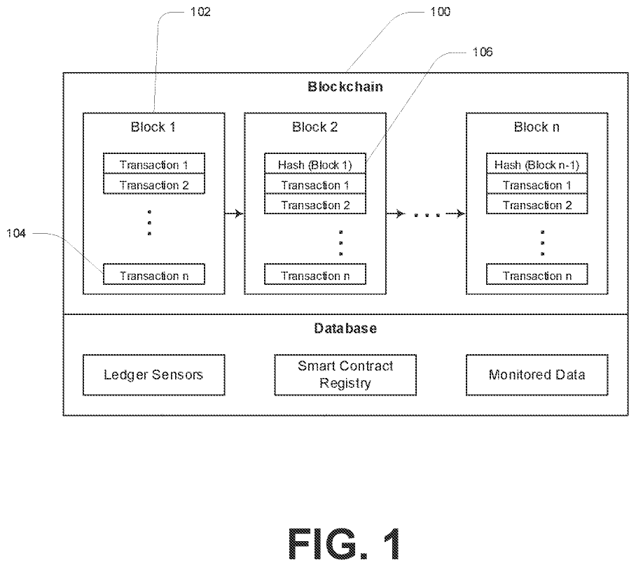

With reference now to FIG. 1, a blockchain 100 includes a plurality of blocks 102. Each block 102 is a data structure that includes data representing transactions 104, for example, smart contracts, payment receipts, or any other transaction. As described above, as new transactions 104 are submitted to the blockchain 100 and validated, additional blocks 102 are generated and appended to the blockchain 100. Each new block 102 also includes a hash 106 of the immediately previous block 102. For example, block 2 includes a hash of block 1, block n includes a hash of block n−1, etc.

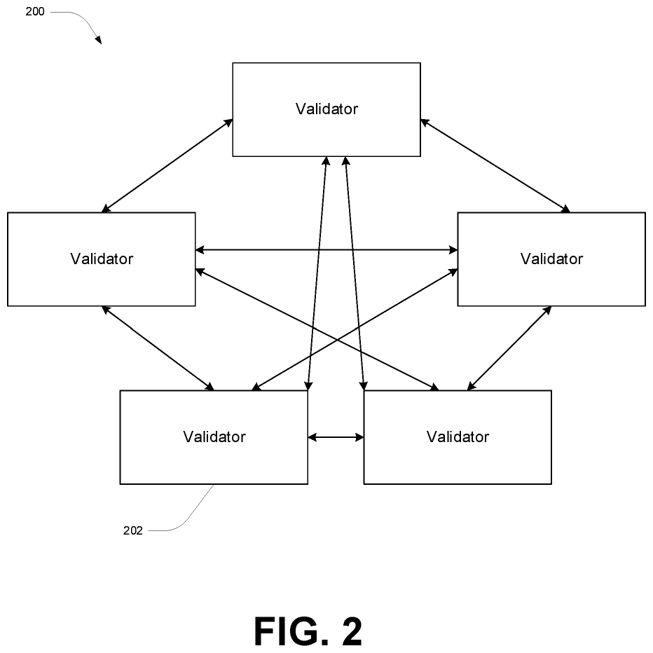

With reference now to FIG. 2, any transactions submitted to blockchain 100 are validated by a set of validator nodes 200 of blockchain 100. Each validator node 202 performs a series of mathematical computations to determine whether a transaction 104 is valid and also determines whether the transaction complies with the rules of the blockchain. A consensus of the set of validator nodes 200 is required to add the transaction 104 to a block 102 for appending to the blockchain 100.

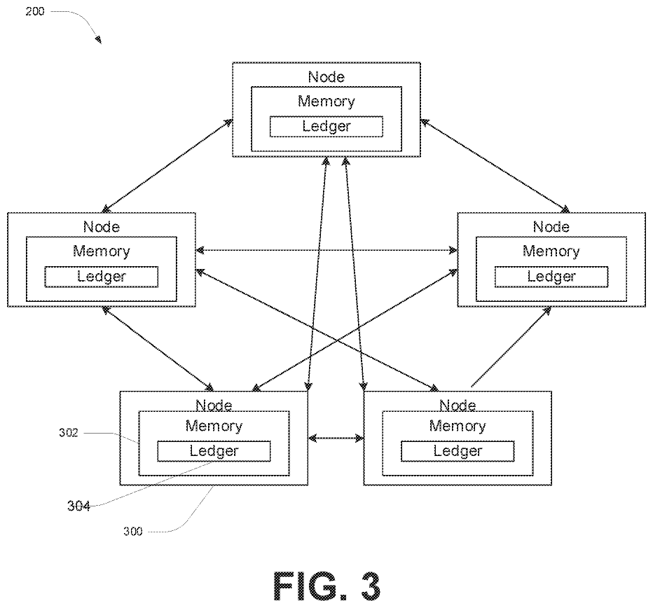

With reference now to FIG. 3, in some aspects, blockchain 100 is stored in a decentralized manner on a plurality of nodes 300. Nodes 300 may each include memory 302 that stores at least a portion of a ledger 304 of blockchain 100. In some aspects, every node 300 may store the entire ledger 304. In some aspects, each node 300 may store a portion of ledger 304. In some aspects, some or all of nodes 300 may be also be validator nodes 200. In some aspects, some or all of blockchain 100 may be stored in a centralized manner.

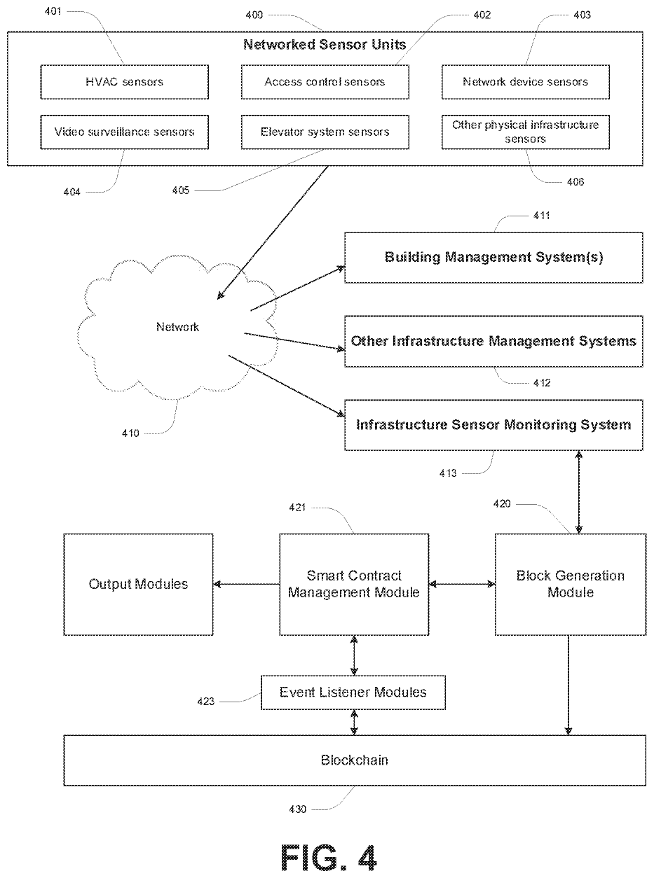

FIG. 4 is a diagram illustrating a technological framework according to one embodiment. This technological framework includes a plurality of networked sensor units 400, including HVAC sensors 401, access control sensors 402, network device sensors 403, video surveillance sensors 404, elevator system sensors 405, and a range of other physical infrastructure sensors 406. These each transmit data onto a network 410, for example, in accordance with the BACNET® protocol (or other data protocols). These sensors pass their data onto the likes of building management systems 411, and other infrastructure management systems 412. Of greatest relevance to the present disclosure, the data is made available via network 410 to an infrastructure sensor monitoring system 413. System 413 includes a first set of infrastructure monitoring modules that are each configured to monitor a respective one or more physical devices associated with the physical infrastructure system, and, for each of the physical devices associated with the physical infrastructure system, determine a current operational parameter. This may be via “pull” or “push” arrangements (for example, using periodic querying for data values, or monitoring for events).

An infrastructure operational state block generation module 420 is configured to, on a defined schedule, execute a process that: (i) analyzes current data from the first set of monitoring modules; (ii) based on the analysis determines a system operational parameter, (iii) writes to a blockchain 430 a block entry that includes an identifier that corresponds to the determined system operational parameter and associated timing information. In this manner, data derived from monitoring of infrastructure operational parameters is periodically written to blockchain 430, providing an immutable objective record of infrastructure operation.

The infrastructure operational state block generation module is optionally configured to use a hybrid arrangement whereby a private ledger (blockchain or otherwise) is used in combination with blockchain 430, for example, to allow periodic data aggregation thereby to reduce the number of blocks written to blockchain 430 (this improves blockchain utilization efficiencies). For example, in one embodiment the block generation module is configured to: write to a private ledger value data for each of a plurality of periodic readings of a given system operational parameter made over a predefined period; at the end of the predefined period, compile the data values for each of the plurality of periodic readings of the given system operational parameter made over the predefined period; and based on the compiling, define the blockchain entry such that the blockchain entry includes an identifier that corresponds to a compiling of the plurality of periodic readings of the given system operational parameter made over the predefined period, and associated timing information.

A smart contract management module 421 operates in combination with one or more listener modules 423. The smart contract management module is configured to execute code embodying a smart contract that accepts as input a plurality of variable values having defined attributes; the listener modules are configured to monitor the blockchain thereby to identify each block entry that provides one of the plurality of variable values having the defined attributes. For each identified block entry that provides one of the plurality of variable values, the listener modules extract the value and deliver that value to the smart contract management module. This, in one embodiment, allows the smart contract management module to process the variable values provided by block entries written to the blockchain by the infrastructure operational state block generation module thereby to determine an infrastructure state result value for a defined period.

The smart contract management module is configured to determine a contract outcome process in response to the determined infrastructure state result value (as defined by code embodying the smart contract under execution). For example, the contract outcome process in some cases includes making of an automated electronic payment, and a payment amount for the payment is determined based on the determined infrastructure state result value. This optionally is configured such that the determined infrastructure state result value provides a scaling factor that is applied to a baseline payment value thereby to, at least in part, enable calculation of the payment amount. As a practical example, the determined infrastructure state result value defines a measure of operation for the relevant physical infrastructure, such as instance uptime vs downtime, and the smart contract defined payment rules that enable determination of a payment amount based on uptime vs downtime (optionally in combination with one or more other factors).

It should be appreciated that the above example provides technology that, in one example, enables determination of a payment amount based on infrastructure performance. In some embodiments, this is a maintenance payment. As noted, the payment amount is optionally determined in combination with one or more other factors. In a further embodiment, which will now be described, the blockchain is additionally used to maintain a record of maintenance events (for example, visitations by maintenance personnel), and that data is used to affect payment amount calculation. For example, a smart contract may be defined to cause maintenance payment based on a combination of infrastructure uptime/downtime in combination with completion of maintenance events based on a maintenance event schedule.

In one such embodiment, monitoring system 413 includes a set of maintenance condition monitoring modules that are each configured to monitor a respective one or more physical devices, and, based on that monitoring identify events having defined characteristics. Block generation module 420 includes a maintenance condition block generation module that is configured to execute, on a defined schedule, a process that: (i) accesses data for a given one of the identified events having defined characteristics; and (ii) writes to a blockchain a block entry that includes an identifier that corresponds to the identified event and associated timing information. The one or more physical devices include a device configured to report on presence of a proximity relationship between a first electronic device and a target location. For example, this may include:
Identification of a device or token associated with maintenance personnel being identified at a defined location, for example, using GPS tracking, BLE beacons, and/or other location monitoring technology.
Identification that a monitored infrastructure device has been transitioned into a servicing/diagnostic mode.
Other automated approaches able to objectively identify that particular maintenance operations and/or visitations have been completed (or are probabilistically predicted to have been completed).

In this context, for the purpose of the smart contract, the plurality of variable values having defined attributes include:
Variable values provided by block entries written to the blockchain by the infrastructure operational state block generation module; and
Variable values provided by block entries written to the blockchain by the maintenance condition block generation module;

From this, the smart contract management module is configured to process the variable values provided by block entries written to the blockchain by the infrastructure operational state block generation module thereby to determine: an infrastructure state result value for a defined period; and a maintenance condition result value for the defined period. The smart contract management module is additional configured to determine a contract outcome process in response to a combination of: the determined infrastructure state result value; and the maintenance condition result value. From this, the contract outcome process optionally includes making of an automated electronic payment, wherein a payment amount for the payment is determined based on a combination of: the determined infrastructure state result value; and the determined maintenance condition result value. For example, the determined infrastructure state result value and the determined maintenance condition result value combine to provide a scaling factor that is applied to a baseline payment value thereby to, at least in part, enable calculation of the payment amount.

By way of practical example, a smart contract may be defined for the purpose of automating maintenance payments in relation to an elevator system in a multi-level building. An outcome determination parameter is determined based on: (i) a level of uptime/downtime for the elevator system (for example, 100% of a baseline payment for X % uptime, 20% discount a baseline payment for Y % uptime, and so on); and (ii) meeting of an agreed maintenance schedule. For example, this parameter may be used to determine automated payments, such as 100% of the baseline payment for A % of maintenance events completed, 10% of the baseline payment for B % of maintenance events completed, and so on.

Block generation modules are configured to write to the blockchain immutable periodic records of elevator system status (thereby to allow determination of uptime/downtime), and also write to the blockchain immutable records representative of maintenance events (which are able to be compared with the agreed maintenance schedule). These block generation modules are optionally defined and initialized in response to execution of the smart contract code. Listener modules, which are also optionally defined and initialized in response to execution of the smart contract code, monitor the blockchain and extract the relevant values regarding uptime/downtime and maintenance events for delivery to the smart contract execution module. This facilitates determination of the payment amount.

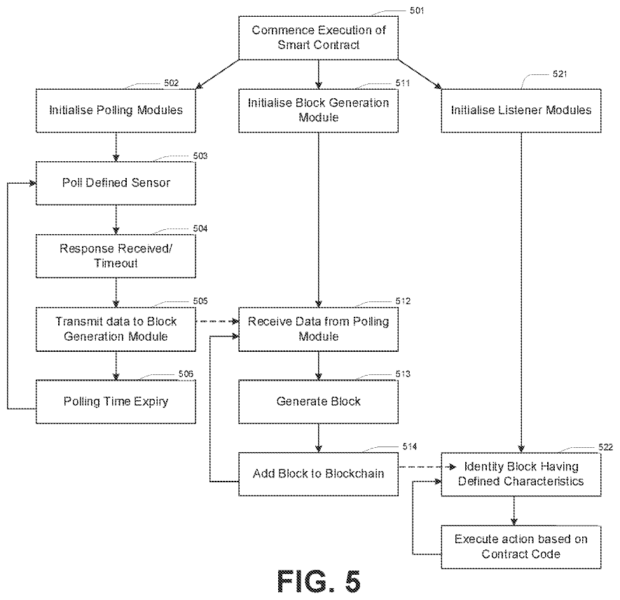

FIG. 5 illustrates an example method according to one embodiment. Block 501 represents commencement of execution of computer code embodying a smart contract. This triggers initialization of a set of polling modules at 502, which are each configured to poll a defined sensor for a defined data value (or non-response) at 503. A response or timeout event occurs at 504, and a resultant data value is transmitted to a block generation module at 505. The polling time expires at 506, and this branch of the method loops to 503.

Block 511 represents initialization of a block generation module. The block generation module receives data from the polling module at 512, and generates a block at 513 (either based solely on the data received at 512, or based on that in combination with other data, including in some examples historical polling data recorded in a private ledger). The generated block is written to a blockchain at 514.

Block 521 represents initiation of listener modules, which monitor the blockchain for blocks containing data values required as inputs for the smart contract. Such a block is identified at block 522, and in response to a data value extracted from the identified block (optionally in conjunction with other data) a variable action is executed in the smart contract.

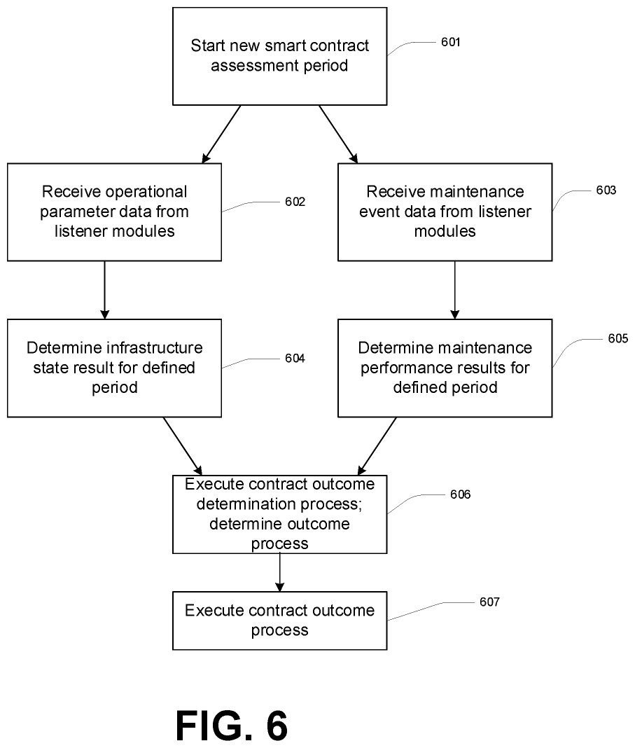

FIG. 6 illustrates a method according to a further embodiment, including a method performed via execution of computer code embodying a smart contract, and, more specifically, a process within a smart contract that includes an assessment period determination, commencing at block 601. This example smart contract is configured to determine a contract outcome process based on a combination of infrastructure uptime and maintenance events. For example, at a practical level, the contracted is coded based on determined KPIs for infrastructure uptime, and KPIs for maintenance work. One set of sensors are used to monitor uptime (and block entries made to establish an immutable record of uptime/downtime on a periodic basis) and another set of sensors to monitor maintenance events, for example, defining blocks based on location monitoring of maintenance personnel, and the like.

Block 602 represents a process including receiving operational parameter data from listener modules, which monitor the blockchain and extract operational parameter data. These are used to determine an infrastructure state result for a defined period at block 604, for example, “A % uptime.” Block 603 represents receiving maintenance event data from listener modules, and maintenance performance results for the period are defined at 605. For example, there may be X events that are anticipated, and Y of these are observed, and in this example X/Y % is defined as a performance result.

Block 606 represents executing a contract outcome determination process, which in this embodiment includes an algorithm that accepts variable of A % and X/Y % as input and from that determines a payment amount for periodic maintenance (for example, from a data table, or based on calculation of a scaling factor that is applied to a baseline value). Then, at 607, a contract outcome process is executed, for example, an instruction to an external system to make a payment of the defined payment amount.

In some embodiments, events and determinations within a smart contract are written to the blockchain as an immutable record of contract execution.

It will be appreciated that technology described above provides a technological framework whereby a range of sensors, for example, sensors provided for the primary purposes of driving a BMS or other primary infrastructure monitoring computer system, are able to be put to a secondary use for driving generation of immutable records in a blockchain setting, and further using those as a means to drive automated operations via execution of smart contracts. One example is monitoring of infrastructure operation and maintenance operations, which, via a smart contract, is tied directly to a maintenance payment schedule, preferably, in a manner that takes into consideration both infrastructure uptime and maintenance event performance. However, it will be appreciated that the underlying technology may be implemented for a range of other purposes.

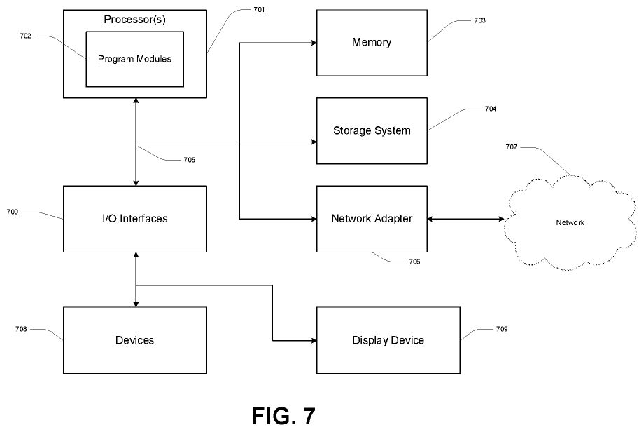

FIG. 7 illustrates a schematic of an example computer or processing system that may implement any portion of blockchain 100, validator nodes 200, nodes 300, systems, methods, and computer program products described herein in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 701, a system memory 703, and a bus 705 that couples various system components, including system memory 703, to processor 701. The processor 701 may include a software module 702 that performs the methods described herein. The module 702 may be programmed into the integrated circuits of the processor 701, or loaded from memory 703, storage system 704, or network 707 or combinations thereof.

Bus 705 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 703 can include computer system readable media in the form of volatile memory, such as random access memory (RAM) and/or cache memory or others. Computer system may further include other removable/non-removable, volatile/non-volatile computer system storage media. By way of example only, storage system 704 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 705 by one or more data media interfaces.

Computer system may also communicate with one or more external devices 708 such as a keyboard, a pointing device, a display device 709, etc.; one or more devices that enable a user to interact with computer system; and/or any devices (e.g., network card, modem, etc.) that enable computer system to communicate with one or more other computing devices. Such communication can occur via Input/Output (I/O) interfaces 709.

Still yet, computer system can communicate with one or more networks 707 such as a local area network (LAN), a general wide area network (WAN), and/or a public network (e.g., the Internet) via network adapter 706. As depicted, network adapter 706 communicates with the other components of computer system via bus 705. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as JAVA®, SMALLTALK™, C++ or the like and conventional procedural programming languages, such as the “C” programming language or similar programming languages, a scripting language such as PERL™, VBS™ or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which-when loaded in a computer system-is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. The embodiment was chosen and described in order to best explain the principles of the present disclosure and the practical application, and to enable others of ordinary skill in the art to understand the present disclosure for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present disclosure may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present disclosure may include and may be included within fixed and portable devices such as desktop, laptop, and/or server. A module may be a component of a device, software, program, or system that implements some “functionality,” which can be embodied as software, hardware, firmware, electronic circuitry, or etc.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments, but only by the scope of the accompanying claims.

It should be appreciated that in the above description of exemplary embodiments of the present disclosure, various features of the present disclosure are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed present disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the present disclosure.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression of device A coupled to a device B should not be limited to devices or systems wherein an output of device A is directly connected to an input of device B. It means that there exists a path between an output of A and an input of B, which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

1. A computer system configured to monitor maintenance conditions for a physical infrastructure system, the system including:
a set of infrastructure monitoring modules that are each configured to monitor a respective one or more physical devices associated with the physical infrastructure system, and, for each of the physical devices associated with the physical infrastructure system, determine a current operational parameter;
an infrastructure operational state block generation module that is configured to, on a defined schedule, execute a process that: (i) analyzes current data from the first set of monitoring modules; (ii) based on the analysis determines a system operational parameter, (iii) writes to a blockchain a block entry that includes an identifier that corresponds to the determined system operational parameter and associated timing information; and
a smart contract management module that operates in combination with one or more listener modules, wherein: (i) the smart contract management module is configured to execute code embodying a smart contract that accepts as input a plurality of variable values having defined attributes; and (ii) the listener modules are configured to monitor the blockchain thereby to identify each block entry that provides one of the plurality of variable values having the defined attributes, and for each identified block entry that provides one of the plurality of variable values, extract the value and deliver that value to the smart contract management module.

2. The system of claim 1, wherein the plurality of variable values having defined attributes include variable values provided by block entries written to the blockchain by the infrastructure operational state block generation module, wherein the smart contract management module is configured to process the variable values provided by block entries written to the blockchain by the infrastructure operational state block generation module thereby to determine an infrastructure state result value for a defined period.

3. The system of claim 2, wherein the smart contract management module is configured to determine a contract outcome process in response to the determined infrastructure state result value.

4. The system of claim 3, wherein the contract outcome process includes making of an automated electronic payment, wherein a payment amount for the payment is determined based on the determined infrastructure state result value.

5. The system of claim 4, wherein the determined infrastructure state result value provides a scaling factor that is applied to a baseline payment value thereby to, at least in part, enable calculation of the payment amount.

6. The system of claim 1, wherein the set of infrastructure monitoring modules that are each configured to monitor a respective one or more physical devices associated with the physical infrastructure system include software modules configured to obtain a defined value from a defined sensor on a defined schedule.

7. The system of claim 6, wherein the defined sensor is a sensor configured for operation in a building management system.

8. The system of claim 1, further comprising:
a set of maintenance condition monitoring modules that are each configured to monitor a respective one or more physical devices, and, based on that monitoring identify events having defined characteristics;
a maintenance condition block generation module that is configured to, on a defined schedule, execute a process that: (i) accesses data for a given one of the identified events having defined characteristics; and (ii) writes to the blockchain the block entry that includes an identifier that corresponds to the identified event and associated timing information.

9. The system of claim 8, wherein the one or more physical devices include a device configured to report on presence of a proximity relationship between a first electronic device and a target location.

10. The system of claim 8, wherein the plurality of variable values having defined attributes include:
(i) variable values provided by block entries written to the blockchain by the infrastructure operational state block generation module; and
(ii) variable values provided by block entries written to the blockchain by the maintenance condition block generation module;
wherein the smart contract management module is configured to process the variable values provided by block entries written to the blockchain by the infrastructure operational state block generation module thereby to determine:
(i) an infrastructure state result value for a defined period; and
(ii) a maintenance condition result value for the defined period.

11. The system of claim 10, wherein the smart contract management module is configured to determine a contract outcome process in response to a combination of: the determined infrastructure state result value; and the maintenance condition result value.

12. The system of claim 11, wherein the contract outcome process includes making of an automated electronic payment, wherein a payment amount for the payment is determined based on a combination of: the determined infrastructure state result value; and the determined maintenance condition result value.

13. The system of claim 12, wherein the determined infrastructure state result value and the determined maintenance condition result value combine to provide a scaling factor that is applied to a baseline payment value thereby to, at least in part, enable calculation of the payment amount.

14. The system of claim 1, wherein the infrastructure operational state block generation module is configured to: write to a private ledger value data for each of a plurality of periodic readings of a given system operational parameter made over a predefined period; at the end of the predefined period, compile the data values for each of the plurality of periodic readings of the given system operational parameter made over the predefined period; and based on the compiling, define the blockchain entry such that the blockchain entry includes an identifier that corresponds to a compiling of the plurality of periodic readings of the given system operational parameter made over the predefined period, and associated timing information.

15. A method for executing a smart contract based on monitoring of one or more sensors that are configured to monitor respective pieces of physical infrastructure, the method including:
configuring an infrastructure operational state block generation to process data derived from a given one of the sensors for a predefined period, thereby to:
(i) on a repeated basis, define an objective measure of infrastructure operational state for the predefined period; and
(ii) write to a blockchain a series of block entries that includes an identifier that, respectively, convey each of the measures of infrastructure operational state for the predefined periods;
configuring one or more listener modules to monitor the blockchain, thereby to identify blockchain entries belonging to the series of blockchain entries, wherein the listener modules are additionally configured to extract from the identified blockchain entries the objective measures of operational state for the predefined periods, and pass those extracted objective measures of operational state to a smart contract management module; and
configuring the smart contract management module to execute computer code embodying a smart contract, wherein the smart contract accepts as input variable values the objective measures of operational state for the predefined periods.

16. The method of claim 15, wherein executing the computer code embodying the smart contract includes determining an outcome process based on analysis of the objective measures of operational state for the predefined periods.

17. The method of claim 16, wherein the outcome process is an automated payment process, and a payment amount for the automated payment process is calculated using a scaling factor derived based on the objective measures of operational state for the predefined periods.

18. A system for enabling smart contract execution based on events defined by a set of sensors that monitor infrastructure in a building environment, the system including:
a smart contract management module configured to execute computer code embodying a smart contract, the smart contract having a plurality of defined data inputs;
a set of block generation modules that are configured to, based on defined rules, write to a blockchain block data defined based on monitoring of data output by one of more of the sensors that monitor infrastructure in a building environment; and
a set of listener modules, wherein the listener modules are configured to monitor the blockchain thereby to extract from the blockchain values corresponding to the defined data inputs of the smart contract;
wherein execution of the smart contract is variable in response to the extracted values corresponding to the defined data inputs.

19. The system of claim 18, wherein at least a subset of the set of sensors that monitor infrastructure in a building environment are configured to deliver data to a building management system.

20. The system of claim 18, wherein the set of block generation modules are initialized in response to execution of a portion of the code embodying the smart contract.
